(19) United States
(12) Patent Application Publication
(10) Pub. No.: US 2013/0208056 A1
(43) Pub. Date: Aug. 15, 2013

(54) LIQUID DROPLET EJECTING HEAD

(71) Applicant: SEIKO EPSON CORPORATION, (US)

(72) Inventors: Eiju HIRAI, Okaya (JP); Shiro YAZAKI, Chino (JP); Hiroshi ITO, Suwa (JP)

(73) Assignee: SEIKO EPSON CORPORATION, Tokyo (JP)

(21) Appl. No.: 13/767,060

(22) Filed: Feb. 14, 2013

(30) Foreign Application Priority Data
Feb. 15, 2012 (JP) 2012-030490

(51) Int. Cl. B41J 2/14

(52) U.S. Cl. CPC B41J 2/14201
USPC 347/71

(57) ABSTRACT

A liquid droplet ejecting head includes an individual electrode provided corresponding to a pressure generating chamber, a piezoelectric layer formed over the individual electrode, and a common electrode formed over the piezoelectric layer and provided across a plurality of the pressure generating chambers. A conductive member is provided outside an active portion of the piezoelectric layer in the longitudinal direction, the conductive member being formed over the piezoelectric layer and being insulated from the individual electrode and the common electrode, the piezoelectric layer being interposed between the individual electrode and the common electrode.

### BACKGROUND

The entire disclosure of Japanese Patent Application No. 2012-030490, filed Feb. 15, 2012 is expressly incorporated by reference herein.

### 1. TECHNICAL FIELD

The present invention relates to a liquid droplet ejecting head.

### 2. RELATED ART

As an ink droplet ejecting device of an inkjet printer and the like which is used for injecting ink, there is for example a liquid droplet ejecting head equipped with a piezoelectric element. In this type of liquid droplet ejecting head, it is possible to change the pressure in a pressure generating chamber formed below the piezoelectric element, by displacing the piezoelectric element using a driving signal and thus to eject droplets of ink and the like supplied into the pressure generating chamber, from a nozzle opening.

For example, this type of liquid droplet ejecting head covers a piezoelectric layer with a common electrode in order to protect the piezoelectric layer of the weak piezoelectric element from external factors such as moisture (see JP-A-2005-88441). This kind of piezoelectric element has an active portion which is interposed between an individual electrode and the common electrode in the piezoelectric layer, and generally, when seen in plan view, this active portion extends in a predetermined direction.

With this kind of piezoelectric element, there are cases in which the amount of displacement at the end of the active portion in the longitudinal direction becomes too large. As a result, there is a possibility that a crack occurs in the piezoelectric layer of the piezoelectric element and reliability is reduced. Therefore, there is a demand for a highly reliable liquid droplet ejecting head in which cracking can be suppressed.

### SUMMARY

An advantage of some aspects of the invention is to provide a highly reliable liquid droplet ejecting head in which cracking can be suppressed.

(1) A liquid droplet ejecting head, according to an aspect of the invention includes an individual electrode corresponding to the pressure generating chamber, a piezoelectric layer formed over the individual electrode, and a common electrode formed over the piezoelectric layer and provided across a plurality of the pressure generating chambers, wherein, a conductive member is provided outside an active portion of the piezoelectric layer in the longitudinal direction, the conductive member being formed over the piezoelectric layer and being insulated from the individual electrode and the common electrode, the piezoelectric layer being interposed between the individual electrode and the common electrode.

In the aspect of the invention, the word “over” refers to, for example, “another specific object (hereinafter referred to as “B”) is formed “over” a specific object (hereinafter referred to as “A”)”, and the like. In the invention, as in the current example, the use of the word “over” includes cases where B is formed over A directly, and cases where B is formed over A via another object. In the same way, the word “under” includes cases where B is formed under A directly, and cases where B is formed under A via another object.

According to the aspect of the invention, a conductive member is provided outside an active portion of the piezoelectric layer in the longitudinal direction, the conductive member being formed over the piezoelectric layer and being insulated from the individual electrode and the common electrode. While it is easy for a crack to occur since the amount of displacement outside of the active portion in the longitudinal direction becomes too large, the amount of displacement can be suppressed by providing the conductive member. Consequently, according to the aspect of the invention, it is possible to provide a highly reliable liquid droplet ejecting head in which cracking can be suppressed.

(2) In the liquid droplet ejecting head, which is one aspect of the invention, the conductive member may overlap a part of an edge portion of the pressure generating chamber.

(3) In the liquid droplet ejecting head, which is one aspect of the invention, the conductive member may be formed from the same material as the common electrode.

(4) In the liquid droplet ejecting head, which is one aspect of the invention, a lead wiring electrically connected to the individual electrode may be provided over the piezoelectric layer, and the conductive member may be formed from the same as the material as the lead wiring.

(5) In the liquid droplet ejecting head, which is one aspect of the invention, a lead wiring electrically connected to the individual electrode may be provided over the piezoelectric layer, and the material of the conductive member may include a first layer formed from the same material as the common electrode, and a second layer formed from the same material as the lead wiring.

(6) In the liquid droplet ejecting head, which is one aspect of the invention, the conductive member may be formed by a plurality of mutually adjacent members.

### BRIEF DESCRIPTION OF THE DRAWINGS

The invention will be described with reference to the accompanying drawings, wherein like numbers reference like elements.

FIG. 1A is a plan view schematically illustrating the main parts of a liquid droplet ejecting head of an embodiment of the invention. FIG. 1B is a cross sectional view schematically illustrating the main parts of a liquid droplet ejecting head of an embodiment of the invention.

FIG. 2 is a cross sectional view schematically illustrating the main parts of a liquid droplet ejecting head of an embodiment of the invention.

FIG. 3 is an exploded perspective view schematically illustrating a liquid droplet ejecting head of an embodiment of the invention.

FIG. 4A is a plan view schematically illustrating the main parts of a modification example 1 of a liquid droplet ejecting head of an embodiment of the invention. FIG. 4B is a cross sectional view schematically illustrating the main parts of a modification example 1 of a liquid droplet ejecting head of an embodiment of the invention.

FIG. 5A is a plan view schematically illustrating the main parts of a modification example 2 of a liquid droplet ejecting head of an embodiment of the invention. FIG. 5B is a cross sectional view schematically illustrating the main parts of a modification example 2 of a liquid droplet ejecting head of an embodiment of the invention.

FIG. 6A is a plan view schematically illustrating the main parts of a modification example 3 of a liquid droplet ejecting head of an embodiment of the invention. FIG. 6B is a cross sectional view schematically illustrating the main parts of a modification example 3 of a liquid droplet ejecting head of an embodiment of the invention.

FIG. 7A is a plan view schematically illustrating the main parts of a modification example 4 of a liquid droplet ejecting head of an embodiment of the invention. FIG. 7B is a cross sectional view schematically illustrating the main parts of a modification example 4 of a liquid droplet ejecting head of an embodiment of the invention.

FIGS. 8A and 8B are cross sectional views schematically illustrating a manufacturing process of a liquid droplet ejecting head of an embodiment of the invention.

FIGS. 9A and 9B are cross sectional views schematically illustrating a manufacturing process of a liquid droplet ejecting head of an embodiment of the invention.

FIG. 10 is a cross sectional view schematically illustrating a manufacturing process of a liquid droplet ejecting head of an embodiment of the invention.

FIG. 11 is a perspective view schematically illustrating a liquid droplet ejecting apparatus.

### DESCRIPTION OF EXEMPLARY EMBODIMENTS

Preferred present embodiments are described in detail below with reference to the accompanying drawings. Firstly, after a description of the structure of a liquid droplet ejecting head 600 of the present embodiment, there is a description of a piezoelectric element 100 which is a main part of the liquid droplet ejecting head 600 of the present embodiment. Further, the embodiments described below do not unreasonably limit the scope of the invention described in the claims. Also, the entirety of the structure described below are not necessarily structural requirements of the invention.

### 1. Liquid Droplet Ejecting Head

### Liquid Droplet Ejecting Head Structure

An example of the liquid droplet ejecting head 600 will be described with reference to the drawings.

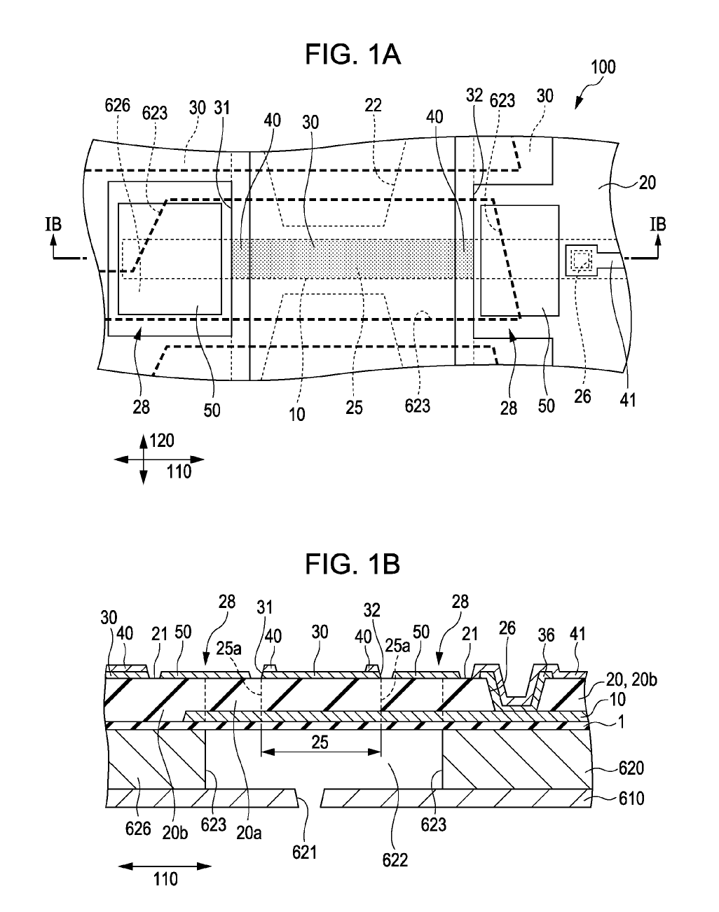

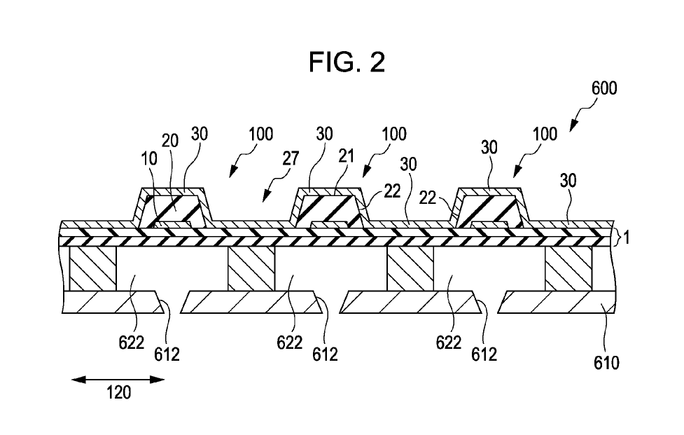

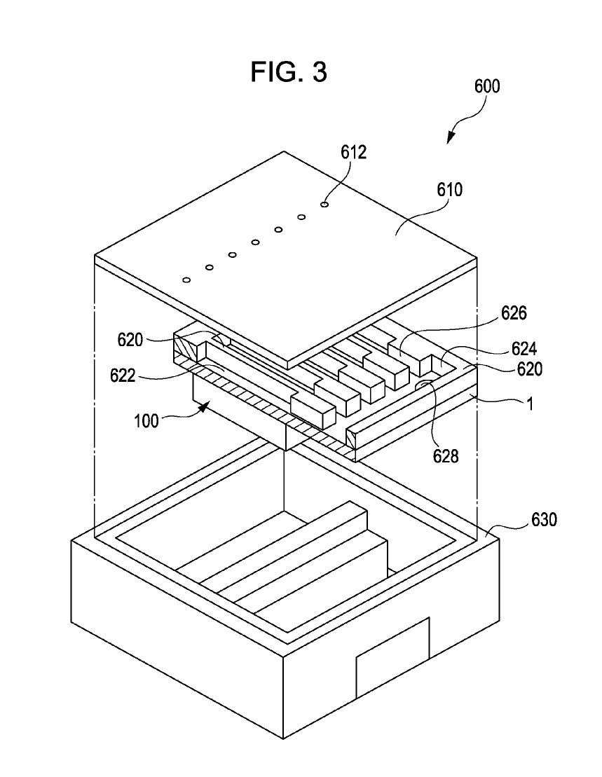

FIG. 1A is a plan view schematically illustrating a piezoelectric element 100 which is a main part of a liquid droplet ejecting head 600 of the present embodiment. FIG. 1B is a cross sectional view taken along line IB-IB of FIG. 1A. FIG. 2 is a cross sectional view schematically illustrating the main parts of a liquid droplet ejecting head of the present embodiment. FIG. 3 is an exploded perspective view of the liquid droplet ejecting head 600 of the present embodiment, and shows a vertically inverted state compared to its normal in-use state. Piezoelectric element 100 is shown in a simplified form in FIG. 3.

As shown in FIGS. 1A to 3, the liquid droplet ejecting head 600 includes a nozzle plate 610 having nozzle openings 612, a flow passage forming plate 620 to form the pressure generating chamber 622, and piezoelectric element 100. The number of piezoelectric elements 100 is not particularly limited, and a plurality of them may be formed. Also, there are cases where the liquid droplet ejecting head 600 has a housing 630, as shown in FIG. 3.

Nozzle plate 610 has nozzle openings 612 as shown in FIGS. 1A to 3. From the nozzle openings 612, liquids such as ink and the like (not only liquids, but also including various functional materials which have been appropriately viscosity-adjusted using solvents or a dispersion medium, or materials containing metal flakes and the like. The same applies below.) can be discharged as droplets. As an example, a plurality of nozzle openings 612 are provided in a row in the nozzle plate 610. As a material for the nozzle plate 610, for example, silicon, stainless steel (SUS) and the like can be used.

Flow passage forming plate 620 is provided over nozzle plate 610 (below in the example of FIG. 3). As a material for the flow passage forming plate 620, for example, silicon or the like can be used. By using the flow passage forming plate 620 to partition the space between the nozzle plate 610 and the substrate 1, as shown in FIG. 3, reservoir (liquid reservoir) 624, a supply port 626 which communicates with the reservoir 624, and a pressure generating chamber 622 which communicates with the supply port 626, are provided (the portion indicated by a broken line in FIG. 1A). In this example, the reservoir 624, supply port 626, and pressure generating chamber 622 are described separately, but they are all the flow paths for liquid and the like, and the design of this kind of flow path is not particularly limited. Also for example, in the example shown, a portion of the flow path of the supply port 626 has a constriction, but this can be formed arbitrarily according to the design, and is not necessarily the essential structure. The reservoir 624, the supply port 626 and the pressure generating chamber 622, are partitioned by the nozzle plate 610, the flow passage forming plate 620, and the substrate 1. The reservoir 624 temporarily stores ink supplied from outside (for example, from an ink cartridge) via the through-hole 628 provided in the substrate 1. The ink in the reservoir 624 is supplied into the pressure generating chamber 622 through the supply port 626. The capacity of the pressure generating chamber 622 is changed by deformation of the substrate 1. The pressure generating chamber 622 communicates with nozzle opening 612, and liquid and the like are discharged from nozzle opening 612 due to changes in the capacity of the pressure generating chamber 622. As shown in FIGS. 1A and 1B, the edge portions (side surfaces) of pressure generating chamber 622 are set as edge portions 623.

The piezoelectric element 100 is provided over flow passage forming plate 620 (below in the example of FIG. 3). The piezoelectric element 100 is electrically connected to a piezoelectric element driving circuit (not shown), and is operated (vibrates, deforms) in accordance with signals from the piezoelectric element driving circuit. A vibrating plate (substrate 1) is deformed by operation of a laminated structure (piezoelectric layer 20) to appropriately change the pressure inside the pressure generating chamber 622.

As shown in FIG. 3, a housing 630 accommodates the nozzle plate 610, the flow passage forming plate 620, and piezoelectric element 100. As a material of the housing 630, for example resin, metal or the like may be used.

Here, a case where the liquid droplet ejecting head 600 is an ink jet type head has been described, however, the liquid droplet ejecting head of the invention may also be used, for example, in a color material ejecting head used for the manufacture of color filters used in liquid crystal displays and the like, in an electrode material ejecting head for forming electrodes for organic EL displays, FED (Field Emission Display) and the like, and in a bio-organic material ejecting head and the like for the manufacture of biochips.

### Piezoelectric Element Structure

Below is a description of the structure of the piezoelectric element 100 included in the liquid droplet ejecting head 600. As shown in FIG. 1A, the piezoelectric element 100 includes an individual electrode 10, a piezoelectric layer 20 formed over the individual electrode 10, and a common electrode 30 formed over the piezoelectric layer 20.

As shown in FIGS. 1A and 1B, the piezoelectric element 100 is formed over the substrate 1. The piezoelectric element 100 may have an active portion 25 (the piezoelectric layer 20 which is interposed between an individual electrode 10 and a common electrode 30) which extends in a predetermined direction when seen in plan view.

Here, a first direction 110 is taken to be the longitudinal direction of the active portion 25 in plan view, and a second direction 120 (lateral direction) is taken to be a direction orthogonal to the first direction.

In the invention, the expression “plan view” means the plan view seen from a normal direction to the surface in which the piezoelectric element 100 of substrate 1 is formed. The same applies below.

FIG. 2 corresponds to a cross sectional view of the active portion 25 (central part) in the second direction 120. A plurality of piezoelectric elements 100 may be provided in parallel along the second direction 120 as shown in FIG. 2. Each of the plurality of piezoelectric elements 100 may be provided so as to correspond to the pressure generating chamber 622.

The substrate 1, on which piezoelectric element 100 is formed, may be formed from a flat plate made from, for example, a conducting material, a semiconducting material, or an insulating material. Further, substrate 1 may be formed as a single layer or as a multiple laminated layer. Also, as long as the upper surface of the substrate 1 is a flat shape, the internal structure is not limited, and for example, may have an internal structure in which spaces and the like are formed.

In the liquid droplet ejecting head 600, substrate 1 is a vibrating plate that performs a mechanical output when the piezoelectric element 100 is operated. The substrate 1 becomes the movable portion of the piezoelectric actuator which includes piezoelectric element 100, and may be structured so as to be a part of the wall of pressure generating chamber 622 and the like. The thickness of substrate 1 may be optimally selected in accordance with the dimensions and driving frequency of the pressure generating chamber 622 described below, the elastic modulus of the material to be used and the like. For example, the thickness of substrate 1 may be equal to or greater than 200 nm and equal to or less than 3000 nm. If the thickness of the substrate 1 is less than 200 nm, it becomes difficult to extract a mechanical output such as vibration, and if the thickness is greater than 3000 nm, there are cases where vibration and the like are not generated. The substrate 1 can be bent or vibrated by the action of the piezoelectric layer 20.

It is preferable for the material of the substrate 1 to have rigidity and high mechanical strength. For the material of the substrate 1, for example, inorganic oxides such as zirconium oxide, silicon nitride, silicon oxide, or metal alloys such as stainless steel may be used. Of these, from the point of view of chemical stability and rigidity, silicon oxide or zirconium oxide are preferable as a material of the substrate 1. The substrate 1 may also have a laminated structure of two or more of the materials exemplified above.

As shown in FIGS. 1A to 2, an individual electrode 10 is provided over the substrate 1 to correspond to the pressure generating chamber 622. The individual electrode 10 is formed to overlap the common electrode 30 described below, and as long as the active portion 25 is formed over the pressure generating chamber 622, the individual electrode 10 is not particularly limited, and may be formed to extend in the first direction 110 as shown in FIG. 1A.

Here, the expression the individual electrode “extends in the first direction 110” in plan view, has the meaning that the width in the first direction is greater than the width in the second direction 120 that is orthogonal to the first direction.

Further, each of the individual electrodes 10 between the plurality of piezoelectric elements are electrically insulated from each other, and “individual electrode” means an electrode in which a driving voltage is applied to each electrode individually. While not illustrated in the drawings, each of the individual electrodes 10 is electrically connected to a driving circuit (not shown).

The structure and material of the individual electrode 10, as long as the material has conductivity, are not particularly limited. As the material for the individual electrode 10, for example, various metals such as Ni, Ir, Au, Pt, W, Ti, Pd, Ag, Ta, Mo, Cr and the like, or their alloys, their conductive oxides (for example iridium oxide and the like), a complex oxide of Sr and Ru, or a complex oxide of La and Ni, can be used. Further, the individual electrode 10 may be formed as a single layer of one of the materials exemplified, or as a multiple laminated layer of a plurality of the above materials. The thickness of the individual electrode 10 is not particularly limited, but may be, for example, equal to or greater than 20 nm and equal to or less than 400 nm.

Furthermore, while not illustrated in the drawings, the individual electrode 10 may have a barrier layer including Ti, a Ti—W alloy or the like. The barrier layer may be provided at the boundary surface between the individual electrode 10 and the substrate 1 (vibration plate), or at the boundary surface between the individual electrode 10 and the piezoelectric layer 20.

Also, while not illustrated in the drawings, the individual electrode 10 may include a layer (adhesive layer) for the purpose of increasing the adhesive strength between the individual electrode 10 and the substrate 1 (vibration plate). The adhesive layer may be formed of titanium or titania (TᵢO₂), zirconia, zirconium or the like.

The piezoelectric layer 20 is formed over individual electrode 10, as shown in FIG. 1B. As shown in FIG. 2, the piezoelectric layer 20 may also be formed over substrate 1. The shape of the piezoelectric layer 20, as long as it covers (coats) the individual electrode 10 over the pressure generating chamber 622, is not particularly limited. As shown in FIGS. 1A to 2, the piezoelectric layer 20 is an integrally formed plate-shaped member in which an opening portion 27 may be formed so as to separate the neighboring piezoelectric elements 100 (each segment), from each other. Here, the side surface of the piezoelectric layer 20 may form a part of the opening portion 27, as shown in FIG. 2.

As shown in FIG. 2, when the surface of piezoelectric layer 20 that comes into contact with the substrate 1 is referred to as a lower surface, the piezoelectric layer 20 may be referred to as having upper surface 21 and side surface 22.

The piezoelectric layer 20 is made from a polycrystalline substance having piezoelectric properties, and it can be made to vibrate by applying a voltage to the piezoelectric element 100. The structure of the piezoelectric layer 20 is not particularly limited as long as it has piezoelectric properties. As for the material for the piezoelectric layer 20, a perovskite-type oxide having a general formula of ABO₃ may be appropriately used. As specific examples of this type of material, lead zirconate titanate (Pb(Zr, Ti)O₃), lead zirconate titanate niobate (Pb(Zr, Ti, Nb) O₃), barium titanate (BaTiO₃), or potassium sodium niobate ((K, Na) NbO₃), or any of the above compounds to which a small amount (for example a few mol % or less) of an element has been added, can be mentioned. The thickness of the piezoelectric layer 20 is not particularly limited, for example, it may be 300 nm or more to 5000 nm or less.

Further, as shown in FIG. 1B, a contact hole 26 may be formed in the piezoelectric layer 20 to expose part of the individual electrode 10. The position of the contact hole 26 is not particularly limited as long as it is over the individual electrode 10 in which the pressure generating chamber 622 is not provided below, moreover, the position must be away from the region where a common electrode 30 described below is provided and away from an exposed region 28. The shape of the contact hole 26 is not particularly limited as long as the individual electrode 10 is exposed.

As shown in FIG. 1B, the piezoelectric layer 20 includes a first portion 20a formed over pressure generating chamber 622. The piezoelectric layer 20 encloses the first portion 20a and includes a second portion 20b which is formed over the flow passage forming plate 620 which forms the wall of the pressure generating chamber 622.

Also, in the first portion 20a of piezoelectric layer 20, an active portion 25 which is the portion interposed between the individual electrode 10 and the common electrode 30 described below is formed. Applying an electric field to the active portion 25 deforms the piezoelectric layer 20 itself (reverse piezoelectric effect), and thereby the substrate 1 can be bent or vibrated. As shown in FIG. 1A, when seen in plan view, the active portion 25 extends in the first direction 110 (portion shown shaded). Also, in FIG. 1B, it can be seen that a boundary surface 25a is formed between the active portion 25 and the inactive portion.

As shown in FIGS. 1A to 2, the common electrode 30 is formed over piezoelectric layer 20 and provided across a plurality of pressure generating chambers 622. Thus the active portion 25 is formed interposed between the individual electrode 10 and the common electrode 30 in the piezoelectric layer 20 over the pressure generating chamber 622. As long as the active portion 25 is formed in the piezoelectric layer 20 over the pressure generating chamber 622, the shape of the common electrode 30 is not particularly limited.

Here “common electrode” refers to an electrode which is formed by a conductive layer provided to give continuity across a plurality of piezoelectric elements, enables the same driving voltage to be applied in common, and to be a shared earth electrode. While not illustrated, the common electrode 30 is electrically connected to a driving circuit (not shown).

As shown in FIGS. 1A and 1B, the common electrode 30 includes edge portions 31 and 32 in the first direction 110 over the first portion 20a of the piezoelectric layer 20. As shown in FIG. 1B, a boundary surface 25a of the active portion 25 is defined by edge portions 31 and 32.

As shown in FIGS. 1A and 1B, the common electrode 30 is patterned on the outside in the first direction 110 (longitudinal direction) of the active portion 25 to form an exposed region 28 exposing the upper surface 21 of the piezoelectric layer 20. The patterning of the common electrode 30 may be performed so that the edge portion 31 becomes a part of the edge portion that forms an opening portion. Further, the patterning may be performed so that edge portion 32 becomes a part of a comb-shaped (or concave) edge portion. In this way, an exposed region 28 is formed that adjoins edge portions 31 and 32 of the common electrode 30 which covers the active portion 25 in the first direction (longitudinal direction) 110.

As long as the material and the structure of the common electrode 30 is conductive, it is not particularly limited. As the material for the common electrode 30, for example various metals such as Ni, Ir, Au, Pt, W, Ti, Pd, Ag, Ta, Mo, Cr and the like, or their alloys, their conductive oxides (for example iridium oxide and the like), a complex oxide of Sr and Ru, or a complex oxide of La and Ni, can be used. Further, the common electrode 30 may be formed as a single layer of one of the materials exemplified, or as a multiple laminated layer of a plurality of the above materials. The thickness of the common electrode 30 is not particularly limited, but may be, for example, equal to or greater than 10 nm and equal to or less than 400 nm.

Also, while not illustrated, the common electrode 30 may be formed so as to extend outside the region in which the plurality of piezoelectric elements 100 are provided, and forms a part of the lead wiring for applying an electric field to the active portion 25.

The lead wiring 40 (indicated by left sloping cross hatching in FIG. 1A) may be formed over the common electrode 30. Therefore, the lead wiring 40 is the leader wiring for the common electrode 30 which is the upper electrode. The lead wiring 40 is electrically connected to a driving circuit which is not illustrated. In this way, the common electrode 30 and the driving circuit are electrically connected. However, in cases where the lead wiring 40 is not formed, as described above, the common electrode 30 itself extends as the lead wiring to electrically connect with the driving circuit.

The lead wiring 40 is patterned so as to at least avoid the central portion (the portion interposed between both edge portions 31 and 32 in the first direction 110) of the common electrode 30 covering the active portion 25 and the exposed region 28 of the piezoelectric layer 20. For example, the lead wiring 40 may be provided so as to cover both edge portions 31 and 32 in the first direction 110 of the common electrode 30 over the active portion 25. By disposing the lead wiring 40 in this way, the lead wiring 40 acts as a physical weight so as to suppress excessive displacement of piezoelectric element 100 occurring in the longitudinal direction, and thereby suppresses the occurrence of cracks in the piezoelectric layer 20.

Also, while not illustrated, the lead wiring 40 may be formed so as to extend outside the region in which the plurality of piezoelectric elements 100 are provided, and forms a part of the lead wiring for applying an electric field to the active portion 25. The lead wiring 40 may be laminated with the common electrode 30 to form an overall lead wiring, or the lead wiring may formed with a single-layer lead wiring 40.

As the material for the lead wiring 40, as long as it has conductivity, there is no specific limitation. Appropriately, a material having higher conductivity than the material used for the common electrode 30 can be used. For example, the lead wiring 40 may contain Au. Further, the lead wiring 40 may also contain copper (Cu) or Ni, Ni—Cr alloy, palladium (Pd) or the like. By using a highly conductive material (a material having high conductivity when compared to the material of the common electrode 30) for lead wiring 40, for the common electrode 30, it is possible to select a material considering adhesion to piezoelectric layer 20, production cost and the like, and suppress a voltage drop due to the resistance of the lead wiring itself between the driving circuit and the piezoelectric element 100. As a result, even in cases where there is a requirement to highly integrate more piezoelectric element segments, the difference between the voltage value set between a plurality of segments and the actually applied voltage value can be made small, and the volume of an ejected liquid droplet can be made closer to the desired volume.

Also, as shown in FIG. 1B, apart from lead wiring 40, a lead wiring 41, which is electrically connected to the individual electrode 10, is provided over piezoelectric layer 20. As shown in FIGS. 1A and 1B, the lead wiring 41 is connected through contact hole 26 both directly and indirectly to the individual electrode 10. As a result, the lead wiring 41 is the leader wiring for the individual electrode 10 which is the lower electrode. The lead wiring 41 is electrically connected to driving circuit which is not illustrated. In this way, the individual electrode 10 and the driving circuit are electrically connected.

The material for lead wiring 41, as long as it is conductive, is not particularly limited. Appropriately, a material having higher conductivity than the material used for the common electrode 30 can be used. Also, the lead wiring 41 may be made from the same material as the lead wiring 40, and may be formed integrally with the lead wiring 40 at the time of manufacture.

While not illustrated in FIG. 1A, as shown in FIG. 1B, a conductive layer 36 may be provided between the individual electrode 10 and the lead wiring 41. The conductive layer 36 is a conductive layer which is formed integrally when patterning the common electrode 30, and prevents damage to the exposed surface of individual electrode 10 during processes such as etching and the like.

As shown in FIGS. 1A and 1B, a conductive member 50 is formed over piezoelectric layer 20 in the exposed region 28 outside the active portion 25 in the longitudinal direction. The conductive member 50 is provided sufficiently far away to maintain insulation from the common electrode 30 and lead wiring 41. For example, if the pitch width between the conductive member 50, and the common electrode 30, or the lead wiring 41 is greater than 5 μm, insulation can be achieved. In this way, conductive member 50 is a member that is insulated from the individual electrode 10 and the common electrode 30.

Since the piezoelectric layer 20 outside in the longitudinal direction of the active portion 25 (in the proximity of the boundary surface 25a) is the boundary region between the active portion 25a, which actively deforms with the application of an electric field, the inactive portion to which no electric field is applied and does not actively deform, stress is concentrated and cracking easily occurs. By providing the conductive member 50 in this kind of region, which does not function as an electrode, but suppresses the displacement of piezoelectric layer 20 by a physical weight effect, and it is possible to effectively suppress the occurrence of cracks.

Further, as shown in plan view in FIGS. 1A and 1B, the conductive member 50 is provided to overlap a part of an edge portion 623 of the pressure generating chamber 622. Since the piezoelectric layer 20 over the edge portion 623 of the pressure generating chamber 622 is a portion in which stress is easily concentrated, by providing conductive member 50 in this way, it is possible to effectively suppresses the occurrence of cracks.

The planar shape and size of the conductive member 50 are not particularly limited, but for example, the planar shape may be rectangular as shown in FIG. 1A. Also, while not illustrated, it may be a planar shape having no corners.

The material of the conductive member 50 may be the same as the material used for common electrode 30. In other words, the conductive member 50 is a member which may be manufactured integrally with common electrode 30. In this way, the provision of a new material film forming and patterning process become unnecessary, so it can be manufactured by a convenient method.

Furthermore, the aspects of conductive member 50 of the piezoelectric element 100 are not limited to those described above. Modification examples of the liquid droplet ejecting apparatus 700 are described below with reference to accompanying drawings. Parts having the same structure as those described above are referred to using the same reference numerals and their detailed descriptions will be omitted.

### Modification Example 1

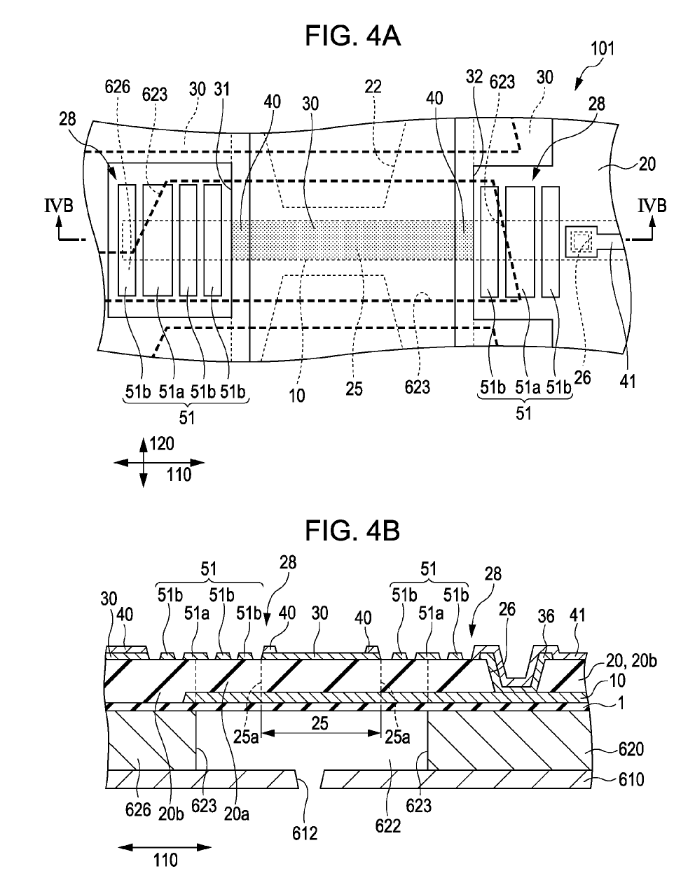

FIG. 4A is a plan view schematically illustrating main parts of a piezoelectric element 101 of modification example 1, and FIG. 4B is a cross sectional view taken along line IVB-IVB of FIG. 4A.

As shown in FIGS. 4A and 4B, a conductive member 51 of the modification example 1 is formed by a plurality of members (51a and 51b) that are mutually adjacent. For example, as shown in FIG. 4A, the conductive member 51 may include a plurality of members in the first direction 110, the widths of which are different from one another. When the member with the largest width in the first direction 110 (the member with the largest area) is made to be the first member 51a, a member with a width in the first direction 110 smaller than that of the first member 51a is made to be the second member 51b. While it is not illustrated, a third member may be formed having a width in the first direction 110 smaller than that of the second member 51b.

The arrangement and planar shape of the conductive member 51, which is formed of a plurality of members, may be appropriately determined with consideration of the stress concentration. As shown in FIG. 4B, there are three regions in the piezoelectric layer 20, (i) a portion which actively deforms due to the application of an electric field (active portion 25), (ii) a portion, in which the lower surface thereof is not fixed, but does not actively deform (first portion 20a excluding active portion 25), and (iii) a portion in which the lower surface thereof is fixed, but does not actively deform (second portion 20b). Further, individual differences occur in regions where displacement should be suppressed due to stress concentration, and regions where displacement should be appropriately suppressed to ensure a constant degree of displacement caused by product usage conditions such as driving voltage or the stiffness of the members used.

Therefore, in the modification example 1, the conductive member 51 is formed by a plurality of members (51a, 51b) which are mutually adjacent, the first member 51a may be disposed over piezoelectric layer 20 where stress concentration easily occurs since the conductive member overlaps the edge portion 623 and is at the border between the first portion 20a and the second portion 20b, and the second member 51b may be disposed in the other regions in which the displacement should be appropriately suppressed. In this way, a constant degree of displacement can be ensured while suppressing the occurrence of cracks.

Also, as previously mentioned, the arrangement and planar shape of the conductive member 51, which is formed of a plurality of members, may be suitably decided with consideration of the stress concentration. A plurality of members 51a and 51b which are configured to extend in the second direction 120, are exemplified in FIG. 4A, however, members which are configured to extend in other directions may be suitably disposed for the purpose of relieving stress (not shown).

### Modification Example 2

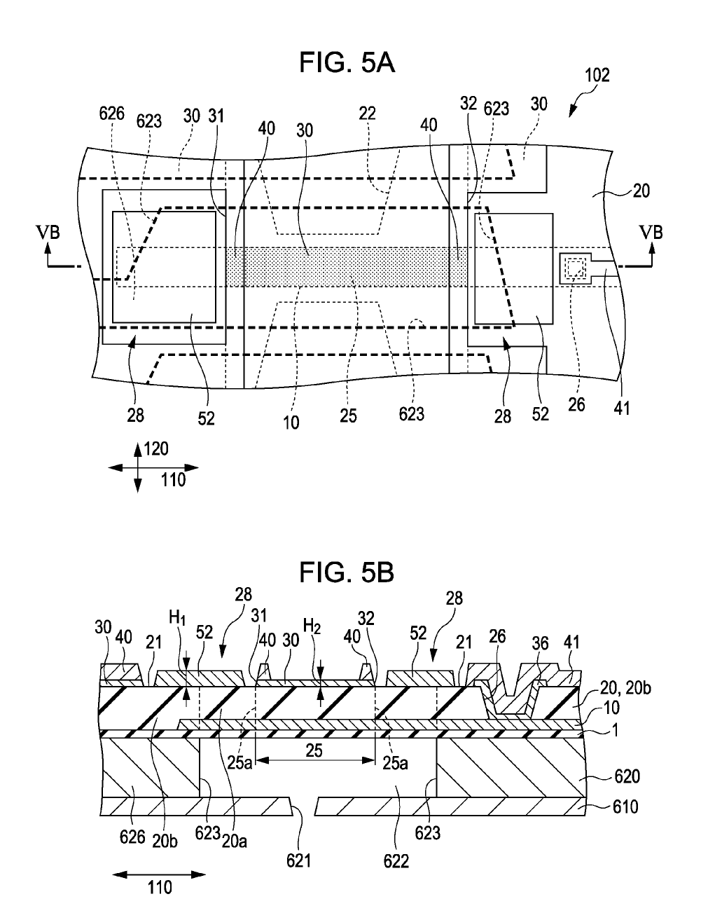

FIG. 5A is a plan view schematically illustrating main parts of a piezoelectric element 102 of modification example 2, and FIG. 5B is a cross sectional view taken along line VB-VB of FIG. 5A.

In modification example 2, as shown in FIGS. 5A and 5B, conductive member 52 is formed from the same material as lead wiring 41 (lead wiring 40). Therefore, conductive member 50 is made from a material with higher conductivity than that used in common electrode 30, (for example, Au or the like).

Further, the film thickness H₁ of conductive member 52 is formed to be thicker than the film thickness H₂ of the common electrode 30. In a case where the film thickness H₂ of the common electrode 30 is equal to or more than 5 nm and equal to or less than 200 nm, the film thickness H₁ of the conductive member 52 may be equal to or more than 500 nm and equal to or less than 2000 nm.

The common electrode 30 is a member which covers the upper surface of active portion 25, and its film thickness (rigidity) affects the degree of displacement of the piezoelectric element. Therefore, the film thickness of the common electrode 30 is limited so as to ensure a useful degree of displacement. Also, since iridium or the like is selected as the material for the common electrode 30, there are greater technical difficulties to achieve film thickness under the film forming process conditions.

However, in the case where the conductive member 52 is formed integrally of the same material as the lead wiring 41, there is no limit to the film thickness. Moreover, since gold or the like is selected as the material for lead wiring 41, film forming in the order of microns is possible under the process conditions, and convenient film forming can be achieved.

Therefore, in modification example 2, where the conductive member 52 is formed from the same material as the lead wiring 41, the conductive member 52 can be formed with a film thickness greater than that of the conductive members 50 and 51 mentioned above, and a greater weight effect can be achieved. Consequently, it is possible to more effectively suppress the occurrence of cracks.

Also, since even greater film thickness formation of lead wiring 40 and 41 can be achieved, the electrical resistance of the overall lead wiring itself can be reduced, and voltage drop can be suppressed.

### Modification Example 3

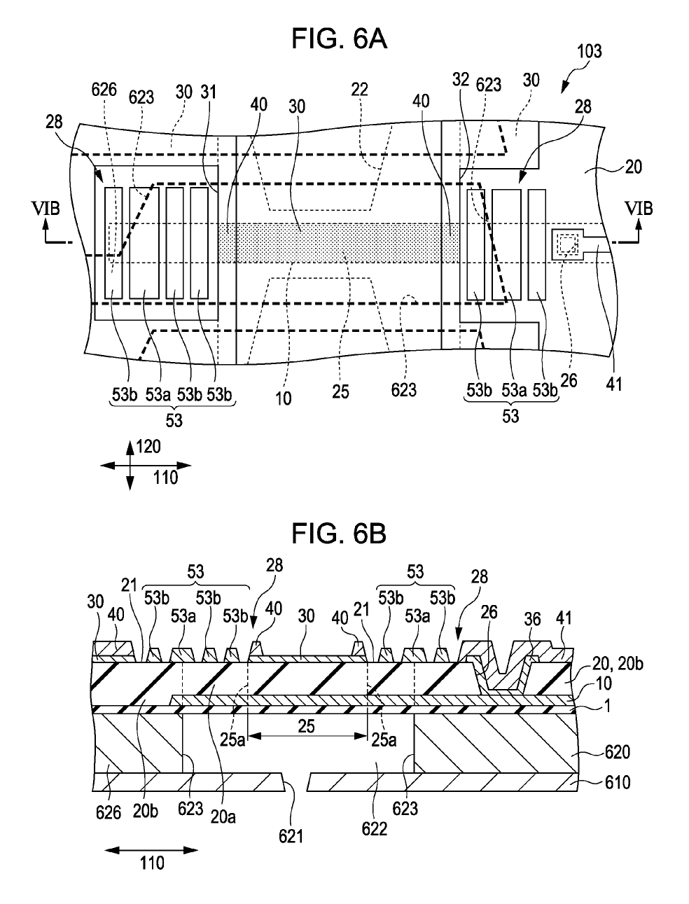

FIG. 6A is a plan view schematically illustrating main parts of a piezoelectric element 103 of modification example 3, and FIG. 6B is a cross sectional view taken along line VIB-VIB of FIG. 6A.

In modification example 3, as shown in FIGS. 6A and 6B, conductive member 53 is formed from the same material as the lead wiring 41, in the same way as in modification example 2. Further, in the same way as in modification example 1, the conductive member 53 is formed of a plurality of mutually adjacent members (53a and 53b). In other words, modification example 3 has the combined aspects of modification example 1 and modification example 2. Specifically, the first member 53a and the second member 53b are disposed with consideration of the stress concentration distribution in the same way as with the first member 51a and the second member 51b, but the film thickness is even greater than the film thickness of the common electrode 30.

As a result, according to modification example 3, in cases where localized stress deformation becomes large, while the occurrence of localized cracks is suppressed, a constant degree of displacement of the piezoelectric element can be ensured.

### Modification Example 4

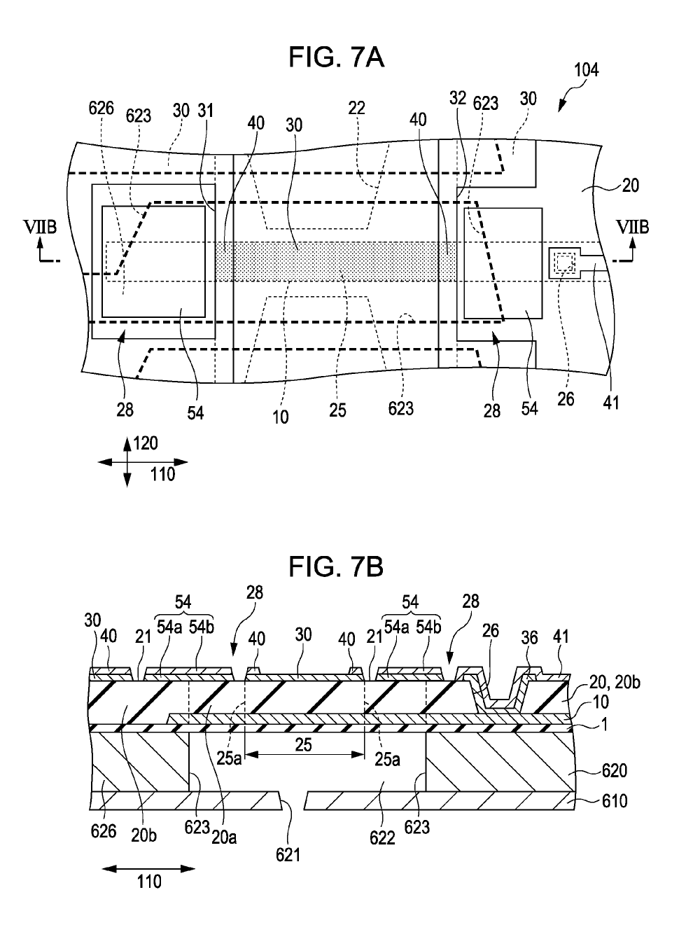

FIG. 7A is a plan view schematically illustrating main parts of a piezoelectric element 104 of modification example 4, and FIG. 7B is a cross sectional view taken along line VIIB-VIIB of FIG. 7A.

In modification example 4, as shown in FIGS. 7A and 7B, conductive member 54 includes a laminate having a first layer 54a formed from the same material as common electrode 30, and a second layer 54b formed from the same material as lead wiring 41 (lead wiring 40). As a result, in modification example 4, since the same characteristics as piezoelectric element 100 can be provided, and the thickness of conductive member 54 can be greater than that of conductive member 50, it is possible to more effectively suppress the occurrence of cracks.

Also, while not illustrated, the aspects of modification example 1 may be applied to modification example 4. Specifically, the conductive member 54 may be formed by a plurality of members (54a and 54b, not shown) which are mutually adjacent.

The liquid droplet ejecting head 600 of the present embodiment includes any one of the above mentioned piezoelectric elements 100 to 104. Consequently, a highly reliable liquid droplet ejecting head 600, in which the occurrence of cracks is suppressed, can be provided.

### 2. Method of Manufacturing Liquid Droplet Ejecting Head

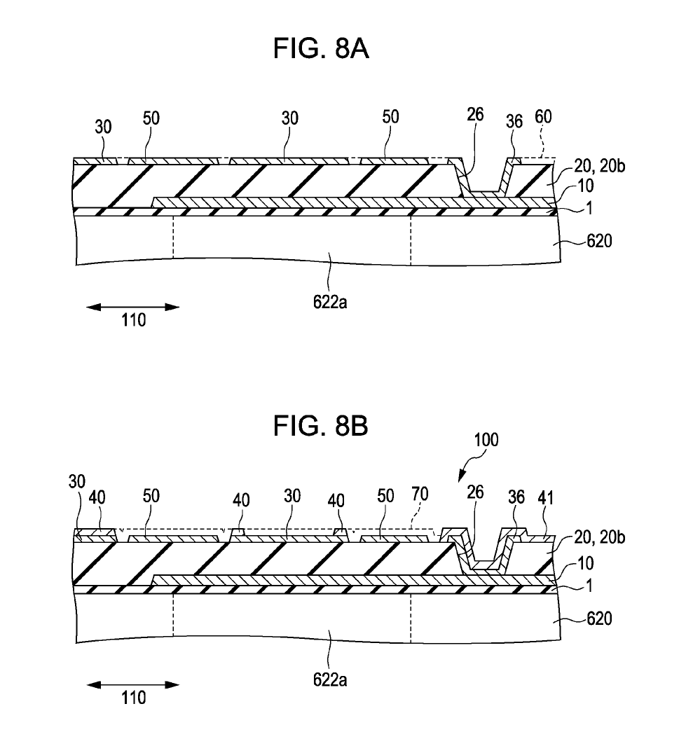

Next, a method of manufacturing the liquid droplet ejecting head 600 is described. FIGS. 8A to 10 are cross sectional views schematically illustrating the manufacturing processes of the liquid droplet ejecting head 600 of the embodiment, (for example, a cross sectional view corresponding to line IB-IB of FIG. 1A). However, known film formation and patterning techniques may be applied to the manufacturing method of the liquid droplet ejecting head 600, and are not limited to the description below.

First, substrate 1 is prepared as shown in FIG. 8A. In cases of manufacturing a liquid droplet ejecting head 600 which includes piezoelectric element 100, a vibration plate formed over the flow passage forming plate 620 is prepared as substrate 1. The prepared flow passage forming plate 620 may or may not have a flow path such as a pressure generating chamber 622. In the embodiment, the flow passage forming plate 620 which does not have a flow path such as a pressure generating chamber 622, but has a region 622a which becomes pressure generating chamber 622 is provided. The substrate 1 is described in detail above, so its description is omitted here.

Next, as shown in FIG. 8A, an individual electrode 10 is formed over substrate 1 (vibration plate). The method of forming the individual electrode 10 is not particularly limited, and known film forming methods can be used. For example, a conductive film is formed using a vapor deposition method such as CVD or PVD, a plating method, sputtering, MOD, spin coating or the like, and an individual electrode 10 having the desired shape can be formed by the known method of patterning the conductive film. The individual electrode 10 is described in detail above, so its description is omitted here.

The known film-forming methods mentioned above may be applied to the forming methods of each member of the conductive layers described below. Also, for the known patterning method used for the manufacture of the piezoelectric element of the embodiment, known photolithographic techniques and/or etching techniques may be used after forming a suitable resist layer matching the desired shape. If etching techniques are used, wet etching or dry etching may be appropriately used.

While not illustrated here, an antioxidation film such as titanium nitride, or an alignment control film to control the alignment of the piezoelectric layer such as the lanthanum-nickel oxide film, titanium film or the like, may be formed over the individual electrode 10 or the substrate 1 (vibrating plate). Also, an adhesive layer such as titanium, chromium or the like may be included between the individual electrode 10 and the substrate 1 (vibrating plate).

Next, the piezoelectric layer 20 is formed over individual electrode 10 as shown in FIG. 8A. The method of forming piezoelectric layer 20 is not particularly limited, and known formation methods may be used. For example, a piezoelectric material film may be formed by the sol-gel method or the like. The piezoelectric material film may also be formed by spin coating, CVD, MOD, sputtering, laser abrasion or the like. Next, the piezoelectric material film is heat treated to crystallize the piezoelectric material. In this way, a piezoelectric film can be formed from the crystallized piezoelectric body. The heat treatment conditions are not particularly limited as long as the temperature is sufficient to crystallize the used piezoelectric material film. Heat treatment may be performed for example at equal to or greater than 500° C. to equal to or less than 800° C. in an oxygen atmosphere. The piezoelectric layer 20 is described in detail above, so its description is omitted here.

Next, the piezoelectric material film is patterned to the desired shape, and the piezoelectric layer 20 is formed. When patterning, the opening portion 27 and the contact hole 26 are formed (refer to FIGS. 2 and 8A).

Next, as shown in FIG. 8A, a conductive layer 60 is formed over piezoelectric layer 20. The main component of the material of the conductive layer 60 may be iridium. The conductive layer 60 is patterned, and common electrode 30 and conductive member 50 may be formed. In this way, the common electrode 30 and the conductive member 50, which are formed from the same material, can be integrally formed in the same process.

As shown in FIG. 8A, patterning may be performed so as to leave the conductive layer 60 inside the contact hole 26, and the conductive layer 36 may be formed. In this way, if etching is performed, it is possible to prevent the surface of individual electrode 10 exposed inside of contact hole 26 from etching damage.

Next, as shown in FIG. 8B, the conductive layer 70 may be formed, and lead wiring 40 and 41 may be formed by patterning the conductive layer to the desired shape. For the material of conductive layer 70, a material having a higher conductivity than that of conductive layer 60 is appropriately selected, for example, gold may be the main component.

From the above, the piezoelectric element 100 may be manufactured. Here, while not illustrated, after the conductive layer 60 and conductive layer 70 are sequentially formed, patterning may be performed to achieve the desired shape.

Further, in the case of manufacturing the piezoelectric element 101 of modification example 1, when patterning conductive layer 60, the piezoelectric element 101 may be manufactured by patterning so as to form the shape shown in FIG. 4A. Also, in the case of manufacturing the piezoelectric element 104 of modification example 4, the conductive layer 60 is formed over piezoelectric layer 20, and when patterning, the conductive layer 60 and conductive layer 70 are sequentially formed, and a first layer 54a and a second layer 54b may be formed.

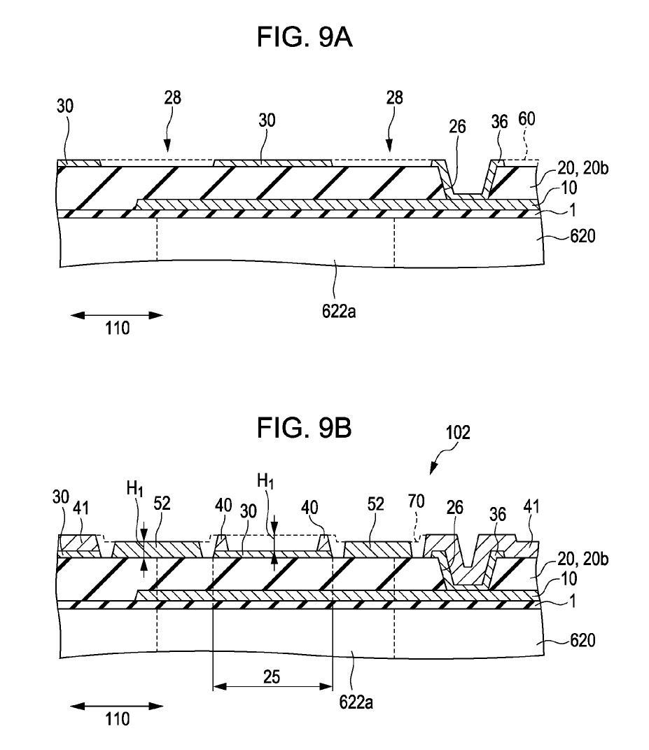

Next, the method of manufacturing the piezoelectric element 102 will be described with reference to the attached drawings of the modification example 2. As shown in FIG. 9A, the individual electrode 10 and the piezoelectric layer 20 are formed using the same methods as described above. However, when patterning conductive layer 60, in the exposed region 28, only the common electrode 30 is formed, but not the conductive layer.

Next, as shown in FIG. 9B, the conductive layer 70 is formed so as to have a film thickness (H₁) greater than the film thickness of conductive layer 60. By this patterning of conductive layer 70, conductive member 52 is formed concurrently with the lead wiring 40 and 41. As a result, the lead wiring 41 (lead wiring 40) and conductive member 52 which are formed from the same material may be formed integrally in the same process.

Also, when manufacturing the piezoelectric element 103 of modification example 3, when patterning the conductive layer 70, the piezoelectric element 103 may be manufactured by patterning so as to achieve the aspects shown in FIG. 6A.

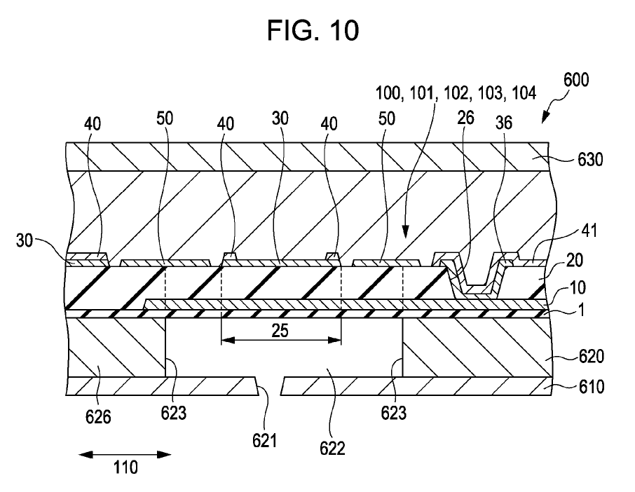

Next, in the case of manufacturing the liquid droplet ejecting head 600 which includes piezoelectric element 100 (102, 103, and 104), as shown in FIG. 10, a flow path such as pressure generating chamber 622 and the like is formed in the flow passage forming plate 620 below the piezoelectric element 100 (102, 103, and 104), and a nozzle plate 610 is provided. Also, as shown in FIG. 10, a housing 630 that includes a sealing plate to seal piezoelectric element 100 (102, 103, and 104) and the like is provided. While not illustrated, the flow passage forming plate 620 and the like may be processed after providing the sealing plate.

### 3. Liquid Droplet Ejecting Apparatus

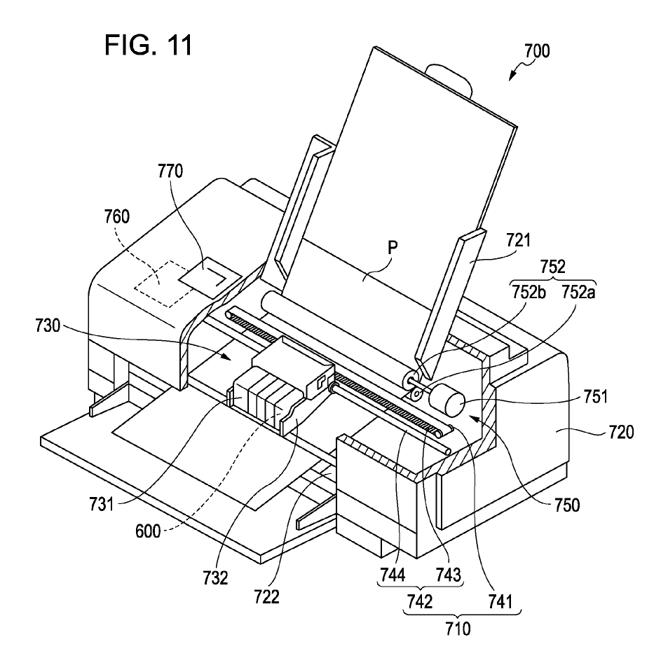

Next, the liquid droplet ejecting apparatus of the embodiment will be described with reference to the accompanying drawings. The liquid droplet ejecting apparatus has the liquid droplet ejecting head described above. Below, the case where the liquid droplet ejecting apparatus is an ink jet printer having a liquid droplet ejecting head 600 is described. FIG. 11 is a perspective view schematically showing the liquid droplet ejecting apparatus 700 of the embodiment.

As shown in FIG. 11, the liquid droplet ejecting apparatus 700 includes a head unit 730, a driving unit 710, and a control unit 760. Further, the liquid droplet ejecting apparatus 700 may also include an apparatus body 720, a paper supply unit 750, a tray 721 in which recording paper P may be placed, a discharge outlet 722 from which recording paper P is discharged, and an operating panel 770 disposed on the upper surface of the apparatus body 720.

The head unit 730 has an ink jet type recording head (also referred to below simply as “head”) configured by liquid droplet ejecting head 600 described above. The head unit 730 is also provided with an ink cartridge 731 which supplies ink to the head, and a transport unit (carriage) 732 in which the head and the ink cartridge 731 are mounted.

The driving unit 710 drives the head unit 730 in a reciprocating motion. The driving unit 710 has a carriage motor 741 which is a drive source for head unit 730, and a reciprocating mechanism 742, which receives the rotation of carriage motor 741 and reciprocates the head unit 730.

The reciprocating mechanism 742 is equipped with a carriage guide shaft 744 in which both ends thereof are supported by a frame (not shown), a timing belt 743 which extends parallel to the carriage guide shaft 744. The carriage guide shaft 744 supports the carriage 732 while allowing it to freely reciprocate. Further, the carriage 732 is fixed to a part of timing belt 743. By the operation of carriage motor 741, the timing belt 743 is made to travel, and the head unit 730 is made to reciprocate guided by carriage guide shaft 744. During this reciprocation, ink is suitably ejected from the head and printing is performed on recording paper P.

In this embodiment, an example is illustrated in which printing is performed while all the liquid droplet ejecting head 600 and the recording paper P move, however, in the liquid droplet ejecting apparatus of the invention, a printing mechanism may be used in which the liquid droplet ejecting head 600 and the recording paper P change their position relative to each other and printing is performed on the recording paper P. Further, in the present embodiment an example is illustrated in which printing is performed on recording paper P. However, in the liquid droplet ejecting apparatus of the invention, the recording medium on which printing may be performed is not limited to paper, and a wide range of recording media such as cloth, film, metal and the like may also be used and suitable modification of the mechanism is possible.

The control unit 760 controls the head unit 730, the driving unit 710, and the paper supply unit 750.

The paper supply unit 750 sends recording paper P from the tray 721 to the head unit 730. The paper supply unit 750 is equipped with a paper supply motor 751 which is a driving source, and paper supply rollers 752 which rotate through operation of the paper supply motor 751. The paper supply rollers 752 are configured by a following roller 752a and a driving roller 752b in opposition above and below the transport path so as to pinch the recording paper P. The driving roller 752b is connected to a supply motor 751. When the paper supply unit 750 is driven by the control unit 760, the recording paper P is fed so as to pass below the head unit 730.

The head unit 730, the driving unit 710, the control unit 760, and the paper supply unit 750 are all provided inside the apparatus main body 720.

The liquid droplet ejecting apparatus 700 includes the liquid droplet ejecting head 600 of the embodiment. Therefore, a liquid droplet ejecting apparatus of improved reliability can be realized.

The liquid droplet ejecting apparatus exemplified above has only one liquid droplet ejecting head, and printing on a recording medium can be performed with this liquid droplet ejecting head. However, the liquid droplet ejecting apparatus may have a plurality of liquid droplet ejecting heads. In a case where the liquid droplet ejecting apparatus has a plurality of liquid droplet ejecting heads, the plurality of liquid droplet ejecting heads may independently operate as described above, or the plurality of liquid droplet ejecting heads may all be joined to each other to form a single compound head. As this kind of compound head, for example, there is a line type head where each of the nozzle holes of the plurality of heads have an overall uniform spacing.

A description of the ink jet recording apparatus 700 was given above as an ink jet printer which is an example of a liquid droplet ejecting apparatus of the invention, however, the liquid droplet ejecting apparatus of the invention may be used industrially. In this case, as the liquid (liquid state material) discharged, various functional materials which have been viscosity-adjusted using solvents or a dispersion medium, and the like may be used. The liquid droplet ejecting apparatus of the invention, apart from the image recording device such as the printer exemplified, may also be suitably used for a color material ejecting apparatus used for the manufacture of color filters used in liquid crystal displays and the like, for forming electrodes for organic EL displays, FED (Field Emission Display), electrophoresis displays and the like, and in a bio-organic material ejecting head and the like for the manufacture of biochips.

The embodiment and various modification examples described above are each single examples, however, the invention is not limited to these examples. For example, it is possible to suitably combine a plurality of the embodiments and the various modification examples.

The invention is not limited to the embodiment described above, various further modification examples are possible. For example, the invention includes structures which are substantially the same as the structure of the described embodiment (for example, the structure in which function, method or result are the same, or the structure in which the purpose or effect are the same). Also, the invention includes structures in which a part which is not substantial in the described embodiment has been replaced. In addition, the invention includes structures which can perform the same actions or achieve the same purposes as the structure of the described embodiment. Also, the invention includes structures in which well-known techniques have been added to the structure described in the embodiment.

What is claimed is:

1. A liquid droplet ejecting head comprising:
an individual electrode provided corresponding to a pressure generating chamber;
a piezoelectric layer formed over the individual electrode; and
a common electrode formed over the piezoelectric layer and provided across a plurality of the pressure generating chambers,
wherein a conductive member is provided outside an active portion of the piezoelectric layer in the longitudinal direction, the conductive member being formed over the piezoelectric layer and being insulated from the individual electrode and the common electrode, the piezoelectric layer being interposed between the individual electrode and the common electrode.

2. The liquid droplet ejecting head according to claim 1,
wherein the conductive member is provided so as to overlap a part of an edge portion of the pressure generating chamber.

3. The liquid droplet ejecting head according to claim 1,
wherein the conductive member is formed from the same material as the common electrode.

4. The liquid droplet ejecting head according to claim 1,
wherein a lead wiring, electrically connected to the individual electrode, is provided over the piezoelectric layer, and
the conductive member is formed from the same material as the lead wiring.

5. The liquid droplet ejecting head according to claim 1,
wherein a lead wiring, electrically connected to the individual electrode, is provided over the piezoelectric layer, and
the conductive member includes a first layer formed from the same material as the common electrode, and a second layer formed from the same material as the lead wiring.

6. The liquid droplet ejecting head according to claim 1,
wherein the conductive member is formed by a plurality of mutually adjacent members.
